(19) United States
(12) Patent Application Publication
(10) Pub. No.: US 2026/0058256 A1
(43) Pub. Date: Feb. 26, 2026

(54) BATTERY PACK

(71) Applicant: Samsung SDI Co., Ltd., Yongin-si (KR)

(72) Inventor: Baeckgi Jung, Yongin-si (KR)

(21) Appl. No.: 19/376,055

(22) Filed: Oct. 31, 2025

Related U.S. Application Data
(63) Continuation-in-part of application No. 17/499,490, filed on Oct. 12, 2021.

(30) Foreign Application Priority Data
Oct. 12, 2020 (KR) 10-2020-0131282

(51) Int. Cl. H01M 10/658; H01M 10/647; H01M 50/209; H01M 50/242; H01M 50/293

(52) U.S. Cl. CPC H01M 10/658; H01M 10/647; H01M 50/209; H01M 50/242; H01M 50/293

(57) ABSTRACT

The present disclosure provides a battery pack. The battery pack includes a plurality of battery cells arranged in a longitudinal direction, a heat insulating sheet between two adjacent battery cells, a first friction sheet that is between the heat insulating sheet and one battery cell of the two adjacent battery cells and includes both non-adhesive surfaces in direct contact with the heat insulating sheet and the one battery cell, and a restraining mechanism configured to provide a compressive force in the longitudinal direction from both ends of the plurality of battery cells. According to the battery pack of the present disclosure, a battery pack including a plurality of battery cells reduces an assembly cost and man-hours for assembling a large number of battery cells, while strengthening lateral stiffness and increasing impact resistance against an external impact applied in the transverse direction intersecting the longitudinal direction in which the battery cells are arranged.

### CROSS-REFERENCE TO RELATED APPLICATION

This application is a continuation-in-part of U.S. patent application Ser. No. 17/499,490, filed on Oct. 12, 2021, which claims priority under 35 U.S.C. § 119 to Korean Patent Application No. 10-2020-0131282, filed on Oct. 12, 2020 in the Korean Intellectual Property Office, the entire disclosures of both of which are incorporated by reference herein.

### BACKGROUND

### 1. Field

The present disclosure relates to a battery pack.

### 2. Description of the Related Art

In general, secondary batteries may be charged and discharged, unlike primary batteries that may not be charged. The secondary batteries may be used as energy sources for mobile devices, electric vehicles, hybrid vehicles, electric bicycles, uninterruptible power supplies, and so on and may each be used in the form of a single battery cell depending on the type of external devices or in the form of a battery pack bundled as a unit by connecting a plurality of battery cells to each other.

Small mobile devices such as cell phones may operate for a certain period of time with an output and capacity of a single battery, but when a long-time operation and a high-power operation are required for a battery used for, for example, an electric vehicle or a hybrid vehicle that consumes much power, a battery pack is usually used due to problems of the output and capacity, and the battery pack may increase an output voltage or an output current according to the number of built-in battery cells.

### SUMMARY

According to an embodiment of the present disclosure, a battery pack including a plurality of battery cells reduces an assembly cost and man-hours for assembling a large number of battery cells, while strengthening lateral stiffness and increasing impact resistance against an external impact applied in the transverse direction intersecting the longitudinal direction in which the battery cells are arranged.

Additional aspects will be set forth in part in the description which follows and, in part, will be apparent from the description, or may be learned by practice of the presented embodiments of the disclosure.

A battery pack according to an aspect of the present disclosure includes
a plurality of battery cells arranged in a longitudinal direction,
a heat insulating sheet between two adjacent battery cells,
a first friction sheet that is between the heat insulating sheet and one battery cell of the two adjacent battery cells and includes both non-adhesive surfaces in direct contact with the heat insulating sheet and the one battery cell, and
a restraining mechanism configured to provide a compressive force in the longitudinal direction from both ends of the plurality of battery cells.

For example, the battery pack may further include a second friction sheet that is between the heat insulating sheet and another battery cell of the two adjacent battery cells and includes a non-adhesive surface in direct contact with the heat insulating sheet and an adhesive surface facing another battery cell.

For example, the first friction sheet and the second friction sheet may be alternately arranged in an alternating order in the longitudinal direction.

For example, the first friction sheet and the second friction sheet may be between the two adjacent battery cells,
the first friction sheet may be between the heat insulating sheet and the one battery cell, and
the second friction sheet may be between the heat insulating sheet and another battery cell.

For example, an adhesive member may be between the second friction sheet and another battery cell.

For example, the first friction sheet may include a central opening and an edge portion surrounding the central opening.

For example, the edge portion may be formed to have a closed shape surrounding the central opening.

For example, one of the plurality of battery cells may include an electrode assembly and a casing member configured to accommodate the electrode assembly, and the casing member may include an upper surface on which an electrode terminal electrically connected to the electrode assembly is formed, a bottom surface opposite to the upper surface, a pair of main surfaces that connect the upper surface to the bottom surface and are relatively wide, and a pair of side surfaces that connect the upper surface to the bottom surface and are relatively narrow.

For example, the edge portion of the first friction sheet may be formed to face the pair of main surfaces of the casing member and extends along edges of the pair of main surfaces.

For example, the edge portion of the first friction sheet may include an upper portion formed at a position adjacent to the upper surface of the casing member, a bottom portion formed at a position adjacent to the bottom surface of the casing member, and side portions formed at positions adjacent to the side surfaces of the casing member. For example, the upper portion and the side portions of the edge portion may be formed so as not to overlap the electrode assembly, and the bottom portion of the edge portion may be formed to overlap the electrode assembly.

For example, the upper portion and the side portions of the edge portion may be formed to overlap the opening of the first friction sheet.

For example, a friction coefficient between the first friction sheet and one of the plurality of battery cells may be in a range of about 0.2 to about 0.8.

For example, the first friction sheet may include at least one of silicone, polyurethane, thermoplastic polyurethane (TPU), and a pressure sensitive adhesive (PSA).

For example, the battery pack may further include a second friction sheet that is between the heat insulating sheet and another battery cell of the two adjacent battery cells and includes a non-adhesive surface in direct contact with the heat insulating sheet and an adhesive surface facing another battery cell, and the first friction sheet and the second friction sheet may be formed of substantially the same material and have the same shape.

For example, the heat insulating sheet may be formed to face an entire main surface of the one battery cell.

For example, the heat insulating sheet may include one of MICA and aerogel.

For example, the restraining mechanism may include plates surrounding the plurality of battery cells arranged in the longitudinal direction.

For example, the restraining mechanism may include a pair of end plates arranged outside outermost battery cells in the longitudinal direction, and a pair of side plates extending in the longitudinal direction to connect the pair of end plates to each other.

For example, the compressive force provided by the restraining mechanism in the longitudinal direction may be in a range of about 2000N to about 5000N.

A battery pack according to another aspect of the present disclosure includes a plurality of battery cells arranged in a longitudinal direction, and an insulating sheet and a friction sheet provided between adjacent pairs of battery cells among the plurality of battery cells, and arranged in an alternating order between adjacent pairs of battery cells in the longitudinal direction in which the plurality of battery cells are arranged.

For example, the plurality of battery cells may be arranged in the longitudinal direction such that main surfaces of the plurality of battery cells face each other, the insulating sheet may have a sheet shape to cover a central portion of the main surface of the battery cell, and the friction sheet may include a central opening formed in the central portion of the main surface of the battery cell and an edge portion surrounding the central opening.

For example, the edge portion of the friction sheet may have a closed shape surrounding the central opening.

For example, a plurality of insulating sheets may be arranged to be spaced apart from each other in units of a pair of battery cells between the plurality of battery cells arranged in the longitudinal direction, with the friction sheet therebetween.

For example, a plurality of friction sheets may be arranged to be spaced apart from each other in units of a pair of battery cells between the plurality of battery cells arranged in the longitudinal direction, with the insulating sheet therebetween.

For example, in a pair of a first battery cell and a second battery cell arranged adjacent to each other in the longitudinal direction in which the plurality of battery cells are arranged, with the friction sheet therebetween, a first surface of the friction sheet facing the first battery cell may be formed as an adhesive surface, and a second surface of the friction sheet facing the second battery cell is formed as a non-adhesive surface.

For example, an adhesive member may be provided between the first battery cell and the first surface of the friction sheet.

For example, a friction coefficient between the second battery cell and the second surface of the friction sheet may range from 0.2 to 0.8.

For example, the friction sheet may include at least one of silicone, polyurethane, TPU, and PSA.

For example, the first battery cell facing the first surface of the friction sheet and the second battery cell facing the second surface of the friction sheet may be arranged in an alternating order in the longitudinal direction in which the plurality of battery cells are arranged.

For example, the battery pack may further include a restraining mechanism configured to provide a compressive force to the plurality of battery cells from both ends of the restraining mechanism in the longitudinal direction in which the plurality of battery cells are arranged.

For example, the restraining mechanism may include plates surrounding the plurality of battery cells arranged in the longitudinal direction.

For example, the restraining mechanism may include a pair of end plates arranged in an outer periphery of an outermost battery cell in the longitudinal direction, and a pair of side plates extending in the longitudinal direction to connect the pair of end plates to each other.

For example, the compressive force provided by the restraining mechanism in the longitudinal direction may range from 2,000 N to 5,000 N.

For example, each of the plurality of battery cells may include an electrode assembly and a casing member configured to accommodate the electrode assembly, and the casing member may include an upper surface on which electrode terminals electrically connected to the electrode assembly are formed, a bottom surface opposite to the upper surface, a pair of relatively wide main surfaces connecting the upper surface to the bottom surface, and a pair of relatively narrow side surfaces connecting the upper surface to the bottom surface.

For example, the friction sheet may include an edge portion facing the pair of main surfaces of the casing member and extending along edges of the pair of main surfaces.

For example, the edge portion of the friction sheet may include an upper portion adjacent to the upper surface of the casing member, a bottom portion adjacent to the bottom surface of the casing member, and side portions adjacent to the side surfaces of the casing member.

For example, a line width of the upper portion of the edge portion, a line width of the side portions of the edge portion, and a line width of the bottom portion of the edge portion may satisfy a size relationship (line width of upper portion>line widths of side portions>line width of bottom portion).

For example, the upper portion and the side portions of the edge portion may not overlap the electrode assembly, and the bottom portion of the edge portion may overlap at least part of the electrode assembly.

For example, the insulating sheet may include one of MICA and an aerogel.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is an exploded perspective view of a battery pack according to an embodiment of the present disclosure;

FIGS. 2 and 3 respectively illustrate an exploded perspective view and a cross-sectional view of a battery cell illustrated in FIG. 1;

FIGS. 4 and 5 are perspective views illustrating a friction sheet between battery cells illustrated in FIG. 1;

FIG. 6 is a view illustrating an arrangement relationship between a friction sheet and an electrode assembly;

FIG. 7A to 7C are views illustrating modified embodiments of the friction sheet illustrated in FIG. 6;

FIGS. 8 and 9 are perspective views illustrating another embodiment of the present disclosure and illustrating friction sheets and insulating sheets between battery cells illustrated in FIG. 1;

FIG. 10 is a view illustrating an example of the friction sheet illustrated in FIGS. 8 and 9;

FIG. 11 is a view illustrating an arrangement relationship between the friction sheet illustrated in FIG. 10 and an electrode assembly;

FIG. 12 is a view illustrating different line widths of an upper portion, side portions, and a bottom portion forming the friction sheet illustrated in FIG. 11, and illustrating a configuration of the line widths differentially formed according to an internal space of a casing member of a battery cell facing the friction sheet; and

FIG. 13 is a view illustrating another arrangement relationship between the friction sheet and the electrode assembly as a modified example of the arrangement relationship between the friction sheet and the electrode assembly illustrated in FIG. 11.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, a battery pack according to a preferred embodiment of the present disclosure will be described with reference to the accompanying drawings.

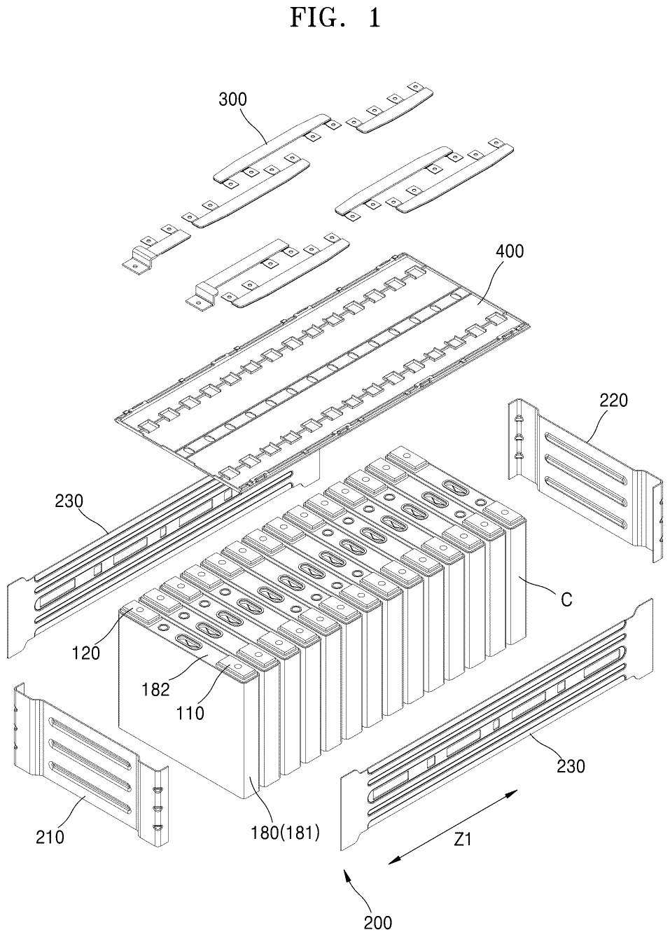

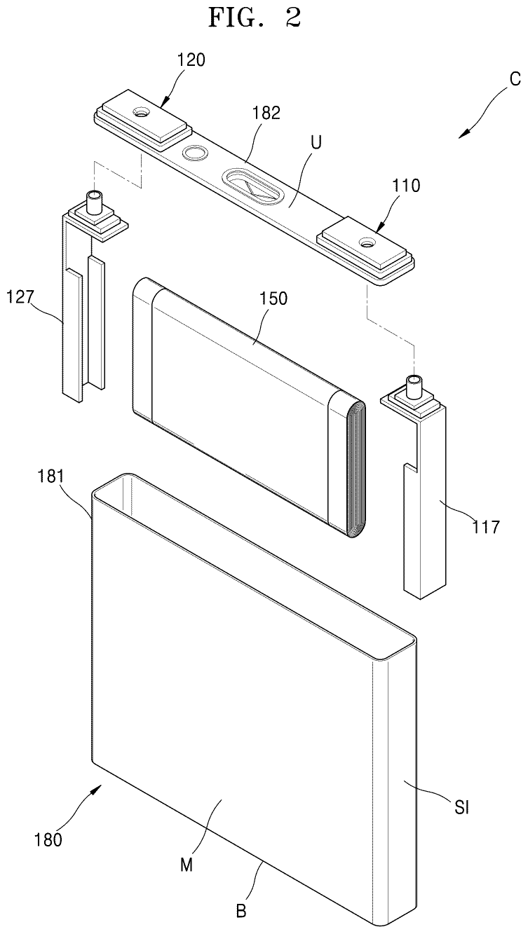

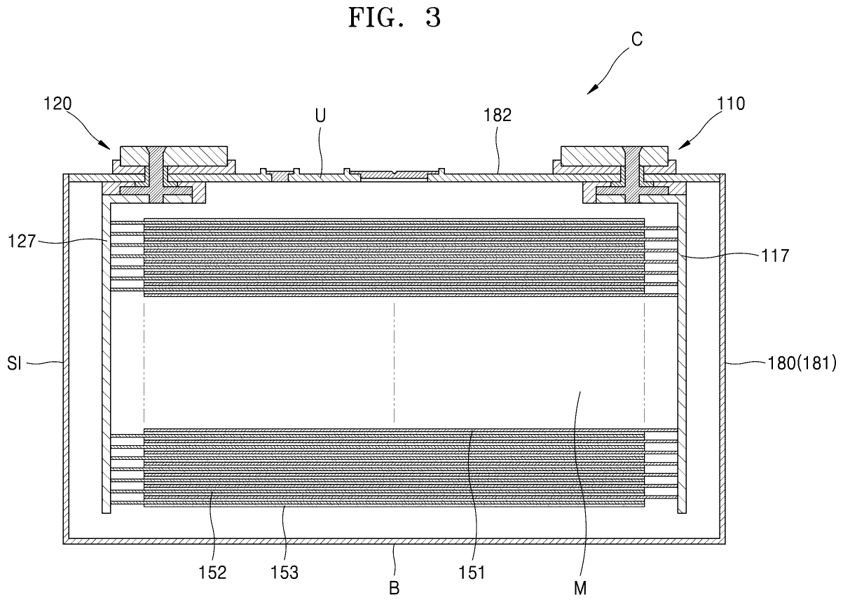

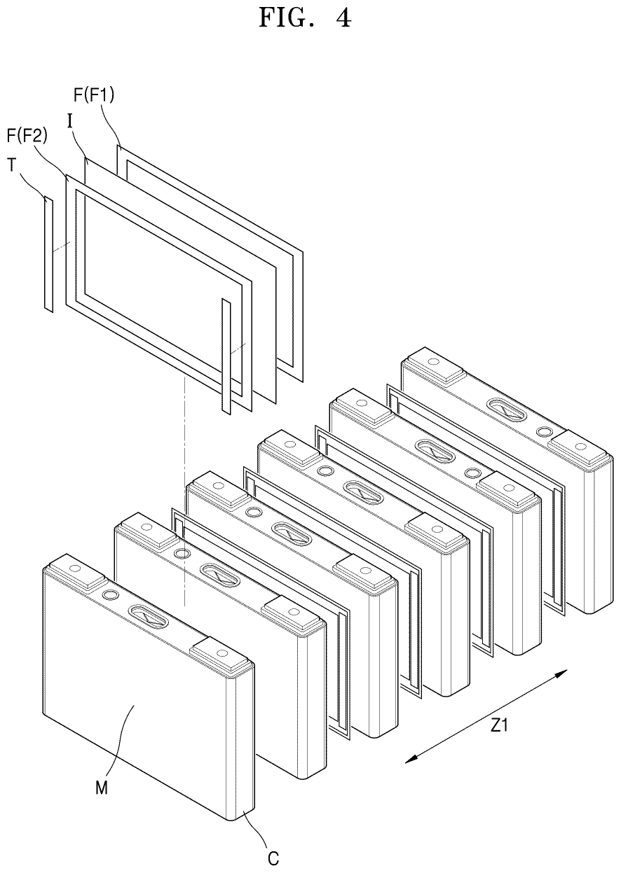

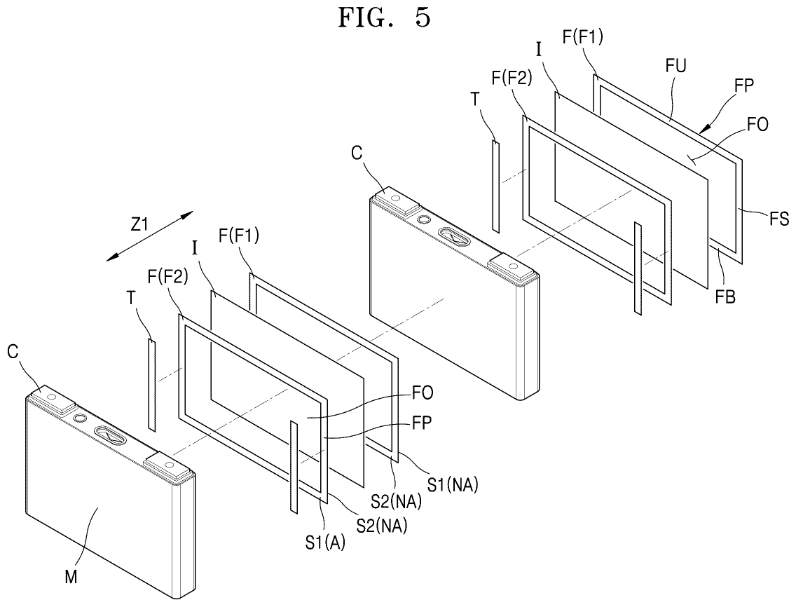

FIG. 1 is an exploded perspective view of a battery pack according to an embodiment of the present disclosure. FIGS. 2 and 3 respectively illustrate an exploded perspective view and a cross-sectional view of the battery cell illustrated in FIG. 1. FIGS. 4 and 5 are perspective views illustrating a friction sheet between battery cells illustrated in FIG. 1.

Referring to FIG. 1, a battery pack according to the present disclosure may include a plurality of battery cells C arranged in a longitudinal direction Z1, a bus bar 300 for electrically connecting the plurality of battery cells C, and a bus bar holder 400 between the plurality of battery cells C and the bus bar 300.

Referring to FIGS. 4 and 5, the battery pack according to the present disclosure may include an heat insulating sheet I between adjacent battery cells C along the longitudinal direction Z1, a first friction sheet F1 that is placed between the heat insulating sheet I and the battery cell C and has non-adhesive surfaces NA on both sides thereof in direct contact with the heat insulating sheet I and the battery cell C, and a restraining mechanism 200 (see FIG. 1) for providing a compressive force along the longitudinal direction Z1 from both ends of the plurality of cells C. Technical details on the first friction sheet F1 will be described below in more detail.

Referring to FIGS. 2 and 3, the battery cell C may include an electrode assembly 150 and a casing member 180 that accommodates the electrode assembly 150. For example, in one embodiment of the present disclosure, the electrode assembly 150 may include first and second electrode plates 151 and 152 and a separator 153 between the first and second electrode plates 151 and 152, and the casing member 180 may include a metal may such as aluminum. In one embodiment of the present disclosure, the casing member 180 may include a may 181 having an upper portion opened to accommodate the electrode assembly 150, and a cap plate 182 for sealing the open upper portion of the may 181.

The casing member 180 may include an upper surface U on which electrode terminals 110 and 120 electrically connected to the electrode assembly 150 are formed, a bottom surface B opposite to the upper surface U, a pair of main surfaces M that connect the upper surface U to the bottom surface B and are formed to have a relatively large area, and a pair of side surfaces SI formed to have a relatively small area. For example, the plurality of battery cells C arranged in the longitudinal direction Z1 may be arranged such that the main surfaces M face each other. The casing member 180 may form an external shape of the plurality of battery cells C, and throughout the present specification, the upper surface U, the bottom surface B, the main surfaces M, and the side surfaces SI of the casing member 180 may correspond to an upper surface U, a bottom surface B, main surfaces M, and side surfaces SI of each of the plurality of battery cells C. In addition, throughout the present specification, portions of the electrode assembly 150 adjacent to the top surface U, the bottom surface B, and the side surfaces SI of each of the plurality of battery cells C are respectively referred to as an upper portion, a bottom portion, and side portions of the electrode assembly 150.

Referring to FIGS. 4 and 5, the heat insulating sheet I and the friction sheet F may be between a pair of the battery cells C adjacent to each other in the longitudinal direction Z1 in which the plurality of battery cells C are arranged. For example, the heat insulating sheet I may be between the pair of adjacent battery cells C, one friction sheet F may be between the heat insulating sheet I and any one of the pair of battery cells C, and another friction sheet F may be between the heat insulating sheet I and the other of the pair of battery cells C. As is described below, the first friction sheet F1 may be between the heat insulating sheet I and any one of the pair of battery cells C, and a second friction sheet F2 may be between the heat insulating sheet I and the other of the pair of battery cells C.

The friction sheet F may include first and second surfaces S1 and S2 on both sides that are between the battery cell C and the heat insulating sheet I in the longitudinal direction Z1 and face the battery cell C and the heat insulating sheet I in the longitudinal direction Z1. More specifically, the friction sheet F may include the first surface S1 facing the battery cell C and the second surface S2 facing the heat insulating sheet I. In this case, at least one of the first and second surfaces S1 and S2 of the friction sheet F may be formed as a non-adhesive surface NA in direct contact with the battery cell C or the heat insulating sheet I. Throughout the present specification, the non-adhesive surface NA may refer to a surface that forms a frictional bond with the battery cell C or the heat insulating sheet I due to a friction force while coming into direct contact with the battery cell C or the heat insulating sheet I without an adhesive member T. In addition, as is described below, an adhesive surface A may refer to a surface that forms an adhesive bond with the battery cell C or the heat insulating sheet I through the adhesive member T. That is, the non-adhesive surface NA and the adhesive surface A of the friction sheet F may be divided according to whether or not there is the adhesive member T between the friction sheet F and the battery cell C or between the friction sheet F and the heat insulating sheet I, and the non-adhesive surface NA that forms a frictional bond and the adhesive surface A that forms an adhesive bond may be divided depending on the type of a bond between the first and second surfaces S1 and S2 of the friction sheet F and the battery cell C, or a bond between the first and second surfaces S1 and S2 of the friction sheet F and the heat insulating sheet I. Here, the adhesive member T may have a form of an adhesive or a shape of a tape and may indicate, for example, a double-sided tape between the friction sheet F and the battery cell C or between the friction sheet F and the heat insulating sheet I.

For example, in one embodiment of the present disclosure, the non-adhesive surface NA and the adhesive surface A of the friction sheet F may form the first surface S1 facing the battery cell C, and the non-adhesive surface NA of the friction sheet F may be in direct contact with the battery cell C depending on whether or not the adhesive member T is interposed, and the adhesive surface A of the friction sheet F may face the battery cell C through the adhesive member T without being in directly contact with the battery cell C. In one embodiment of the present disclosure, the second surface S2 of the friction sheet F may be formed as the non-adhesive surface NA in direct contact with the heat insulating sheet I.

In one embodiment of the present disclosure, the friction sheet F may include the first friction sheet F1 having the first surface S1 of the non-adhesive surface NA in direct contact with the battery cell C, and the second friction sheet F2 having the first surface S1 of the adhesive surface A facing the battery cell C. That is, the first friction sheet F1 may have the first surface S1 of the non-adhesive surface NA in direct contact with the battery cell C, and the second surface S2 of the non-adhesive surface NA in direct contact with the heat insulating sheet I. In addition, the second friction sheet F2 may have the first surface S1 of the adhesive surface A facing the battery cell C, and the second surface S2 of the non-adhesive surface NA in direct contact with the heat insulating sheet I.

The first and second friction sheets F1 and F2 may be alternately arranged in the longitudinal direction Z1 in which the plurality of battery cells C are arranged and may be alternately arranged in an alternating order. For example, the heat insulating sheet I may be between the pair of battery cells C adjacent to each other in the longitudinal direction Z1, and the first friction sheet F1 may be between the heat insulating sheet I and any one of the pair of battery cells C, and the second friction sheet F2 may be between the heat insulating sheet I and the other of the pair of battery cells C.

The first and second friction sheets F1 and F2 are described in more detail as follows. That is, the first friction sheet F1 may have the first and second surfaces S1 and S2 of the non-adhesive surfaces NA, which are respectively in direct contact with the battery cell C and the heat insulating sheet I, between the battery cell C and the heat insulating sheet I. The first friction sheet F1 may bond the battery cell C and the heat insulating sheet I together through a frictional bond, and more specifically, the first friction sheet F1 may bond the battery cell C and the heat insulating sheet I together through the first surface S1 that forms a frictional bond with the battery cell C and the second surface S2 that forms a frictional bond with the heat insulating sheet I. In this case, the frictional bond between the first surface S1 of the first friction sheet F1 and a surface facing the battery cell C may indicate a bond that removes relative moving between the first friction sheet F1 and the battery cell C in a transverse direction intersecting the longitudinal direction Z1 due to a friction force proportional to a compressive force of the restraining mechanism 200 (see FIG. 1). In addition, a direction in which the relative moving between the first friction sheet F1 and the battery cell C is removed by a friction force, that is, the transverse direction intersecting the longitudinal direction Z1 may indicate all directions on a plane of the surface S1 of the first friction sheet F1. Similarly, a frictional bond between the second surface S2 of the first friction sheet F1 and the surface facing the heat insulating sheet I may indicate a bond that removes relative moving between the first friction sheet F1 and the heat insulating sheet I in the transverse direction intersecting the longitudinal direction Z1 due to a friction force proportional to a compressive force of the restraining mechanism 200 (see FIG. 1).

The second friction sheet F2 may have the first surface S1 of the adhesive surface A that forms an adhesive bond with the battery cell C, and the second surface S2 of the non-adhesive surface NA that forms a frictional bond with the heat insulating sheet I. More specifically, the second friction sheet F2 may bond the battery cell C and the heat insulating sheet I together through the first surface S1 that forms an adhesive bond with the battery cell C, and the second surface S2 that forms a frictional bond with the heat insulating sheet I. In this case, the adhesive bond between the first surface S1 of the second friction sheet F2 and the surface facing the battery cell C may indicate a bond that removes relative moving between the second friction sheet F2 and the battery cell C in the transverse direction intersecting the longitudinal direction Z1 due to an adhesive force of the adhesive member T between the first surface S1 of the second friction sheet F2 and the battery cell C. In this case, the direction in which the relative moving between the second friction sheet F2 and the battery cell C is removed by the adhesive force of the adhesive member T, that is, the transverse direction intersecting the longitudinal direction Z1 may indicate all directions on a plane of the first surface S1 of the second friction sheet F2.

In addition, a frictional bond between the second surface S2 of the second friction sheet F2 and the surface facing the heat insulating sheet I may indicate a bond that removes relative moving between the second friction sheet F2 and the heat insulating sheet I in the transverse direction intersecting the longitudinal direction Z1 due to a friction force proportional to the compressive force of the restraining mechanism 200 (see FIG. 1). In this case, a direction in which relative moving between the second friction sheet F2 and the heat insulating sheet I is removed by a friction force of the second friction sheet F2, that is, the transverse direction intersecting the longitudinal direction Z1 may indicate all directions on a plane of the second surface S2 of the friction sheet F2.

Referring to FIG. 1, the battery pack according to the embodiment of the present disclosure may include the restraining mechanism 200 for binding the plurality of battery cells C arranged in the longitudinal direction Z1 in the form of one pack. Throughout the present specification, the restraining mechanism 200 may indicate a structure for binding the plurality of battery cells C in the longitudinal direction Z1. In addition, the restraining mechanism 200 may indicate a structure for applying a friction force to the non-adhesive surface NA of the friction sheet F for restricting the plurality of battery cells C in the transverse direction intersecting the longitudinal direction Z1. That is, the non-adhesive surface NA of the friction sheet F forms a frictional bond with the battery cell C or the heat insulating sheet I in direct contact therewith and forms a frictional bond through a friction force proportional to the compressive force provided by the restraining mechanism 200 in the longitudinal direction Z1. In this case, the compressive force provided by the restraining mechanism 200 may act as a normal force for the friction sheet F.

Referring to FIGS. 4 and 5, unlike the first friction sheet F1 that forms a frictional bond with the battery cell C, the second friction sheet F2 forms an adhesive bond with the battery cell C. In one embodiment of the present disclosure, there is no need to interpose the adhesive member T between the first friction sheet F1 and the battery cell C, and thus, a manufacturing cost and assembly man-hours may be reduced. However, when there are no adhesive members T between all the battery cells C and the friction sheets F, temporary holding or fixing of the battery cells C and the friction sheets F during an assembly operation may not be made, and thus, the adhesive member T is between the battery cell C and the second friction sheet F2 among the first and second friction sheets F1 and F2 alternately arranged with each other, thereby increasing convenience of an assembly during the assembly operation through the temporary fixing between the second friction sheet F2 and the battery cell C.

The first and second friction sheets F1 and F2 may have substantially the same structure. For example, the first and second friction sheets F1 and F2 may be formed of substantially the same material and have the same shape. There are different frictional bonds and different adhesive bonds between the first friction sheet F1 and the battery cell C and between the second friction sheet F2 and the battery cell C, but there is the same frictional bond between the first friction sheet F1 and the heat insulating sheet I and between the second friction sheet F2 and the heat insulating sheet I, and thus, the same friction properties may be required for the first and second friction sheets F1 and F2, and when the first and second friction sheets F1 and F2 have different structures, a strict assembly is required to prevent confusion between the first and second friction sheets F1 and F2 during an assembly operation of the battery pack, which causes inconvenience. As is described below, the first and second friction sheets F1 and F2 may be formed to face the main surfaces M of the battery cell C and may be formed to have substantially the same shape extending along edges of the main surfaces M.

In one embodiment of the present disclosure, the friction sheet F may be formed of an elastic material that has an appropriate friction coefficient to form a sufficient frictional bond with the battery cell C or the heat insulating sheet I and may be elastically deformed appropriately according to a compressive force provided by the restraining mechanism 200 (see FIG. 1). For example, the friction sheet F may be made of an elastic material having a friction coefficient of about 0.2 to about 0.8, and in a specific embodiment of the present disclosure, the friction sheet F may include at least one of silicone, polyurethane, thermoplastic polyurethane (TPU), and a pressure sensitive adhesive (PSA).

The friction sheet F may remove relative moving with the battery cell C or the heat insulating sheet I in the transverse direction intersecting the longitudinal direction Z1 while forming a frictional bond with the battery cell C or the heat insulating sheet I, and the entire battery pack including the plurality of battery cells C arranged in the longitudinal direction Z1 with the friction sheets F therebetween may have lateral rigidity. The lateral rigidity of the battery pack may indicate that, when an external impact is applied in a transverse direction intersecting the longitudinal direction Z1 in which the plurality of battery cells C are arranged, the battery cells C may slide over each other to be out of a regular position. In this case, the fact that the plurality of battery cells C are out of positions due to an external impact may mean that the battery pack operates abnormally due to failure of an electrical coupling, insulation, or so on in which the plurality of battery cells (C) are stably maintained in original positions. In the present disclosure, in order to prevent a shape of the battery pack from being deformed due to an external impact, lateral stiffness may be provided to the battery pack to resist against the external impact in a transverse direction, and thus, impact resistance is increased.

In order to increase a bonding strength of the friction sheet F directly related to the lateral stiffness of the battery pack, the friction sheet F may have an appropriate friction coefficient, for example, a friction coefficient of about 0.2 to about 0.8. Here, the friction coefficient is surface characteristics between the friction sheet F and the battery cell C, and thus, throughout the present specification, the friction coefficient of the friction sheet F may refer to a friction coefficient between the friction sheet F and the battery cell C. Here, the battery cell C may include a can-type battery cell C including a metal may (for example, an aluminum can) as the casing member 180. The friction coefficient is a factor for determining a strength of a frictional bond, and may determine not only a strength of a friction bond between the friction sheet F and the battery cell C but also a strength of a frictional bond between the friction sheet F and the heat insulating sheet I, and a can-type battery cell C using a metal may (for example, an aluminum can) as the casing member 180 has a smooth surface, whereas the insulating sheet I including MICA or aerogel has a rougher surface than the metal may (for example, an aluminum can) as described below, and thus, when the friction sheet F is within a range of the friction coefficient of the friction sheet F, the friction sheet F may form a sufficient frictional bond with the battery cell C while also forming a sufficient frictional bond with the heat insulating sheet I. For example, the lateral stiffness of the battery pack including the plurality of battery cells C may be affected by the strength of the frictional bond between the friction sheet F and the battery cells C and the strength of the frictional bond between the friction sheet F and the heat insulating sheet I, and the friction sheet F having an appropriate friction coefficient forms a sufficient frictional bond with not only the battery cell C but also the heat insulating sheet I, thereby providing lateral stiffness capable of effectively resisting against an external impact.

When the friction coefficient of the friction sheet F increases, a bonding strength with the battery cell C or the heat insulating sheet I increases by that amount, and in addition, the friction sheet F having an excessive friction coefficient outside a range of the friction coefficient may lack elasticity that may be elastically deformed according to a compressive force provided by the restraining mechanism 200 (see FIG. 1), and thus, the range of the friction coefficient may be appropriately limited.

The bonding strength of the friction sheet F and the friction coefficient of the friction sheet F may be affected by the compressive force provided by the restraining mechanism 200 (see FIG. 1) and a contact area between the friction sheet F and the battery cell C. The friction coefficient of the friction sheet F is the same as described above, and the compressive force provided by the restraining mechanism 200 (see FIG. 1) may be in a range of 2000N to 5000N. In addition, the contact area between the friction sheet F and the battery cell C may be in a range of 3000 mm² to 6000 mm². For example, the bonding strength of the friction sheet F may be determined by a friction force expressed in the form of a multiplication of the friction coefficient of friction sheet F (a friction coefficient between the friction sheet F and the battery cell C), the compressive force (corresponding to a normal force) of the restraining mechanism 200 (see FIG. 1) acting between the friction sheet F and the battery cell C, and the contact area between the friction sheet F and the battery cell C. The friction sheet F forms a frictional bond with not only the battery cell C but also the heat insulating sheet I, and the lateral stiffness of the battery pack including the plurality of battery cells C is affected by the strength of the frictional bond between the friction sheet F and the battery cell C and the strength of the frictional bond between the friction sheet F and the heat insulating sheet I, and the friction sheet F having an appropriate friction coefficient forms a sufficient frictional bond with not only the battery cell C but also the heat insulating sheet I, thereby providing lateral stiffness capable of effectively resisting against an external impact. For example, in one embodiment of the present disclosure, the battery cell C may be provided as a can-type battery cell C using a metal may (for example, an aluminum can) as the casing member 180, the insulating sheet I including MICA or aerogel has a rougher surface than a metal may (for example, an aluminum can), rather than a surface of a metal may having a relatively smooth surface, and thus, as described above, the friction sheet F having the friction coefficient and a friction area of the metal may may form a sufficient frictional bond with the battery cell C while also forming a sufficient frictional bond with the heat insulating sheet I. In addition, the compressive force provided by the restraining mechanism 200 (see FIG. 1) may be applied to the friction sheet F, the battery cell C, and the heat insulating sheet I arranged in the longitudinal direction Z1 in the same manner as applied between the friction sheet F and the battery cell C and between the friction sheet F and the heat insulating sheet I.

The lateral stiffness of the battery pack including the plurality of battery cells C may be determined by a friction force between the friction sheet F and the battery cell C and the friction force between the friction sheet F and the heat insulating sheet I and may be determined by a friction force between the friction sheet F and the battery cell C having a relatively smooth metal surface (corresponding to a metal may and the casing member 180) rather than a friction force between the friction sheet F and the heat insulating sheet I having a relatively rough surface. For example, a lateral stiffness of a battery pack against an external impact may be limited by the friction force between the friction sheet F and the battery cell C having a smooth metal surface (corresponding to a metal may and the casing member 180) that is relatively vulnerable to a frictional bond. Under the following conditions according to an embodiment of the present disclosure, that is, under the conditions of a friction coefficient (about 0.2 to about 0.8) between the friction sheet F and the battery cell C, a contact area (about 3000 mm² to about 6000 mm²) between the friction sheet F and the battery cell C, and a compressive force (corresponding to a normal force, about 2000N to about 5000N) of the restraining mechanism 200 (see FIG. 1) applied between the friction sheet F and the battery cell C, a friction force expressed in the form of multiplication of the friction coefficient and the contact area and the compressive force may be in a range of about 400N to about 4000N, lateral stiffness of a battery pack provided by the friction force in the range may effectively resist against an external impact in the transverse direction approximately equivalent to the above-described range of friction force, and the plurality of battery cells C may be in a regular position in the transverse direction.

Referring to FIG. 1, in one embodiment of the present disclosure, the restraining mechanism 200 may include plates 210, 220, and 230 surrounding the plurality of battery cells C arranged in the longitudinal direction Z1. More specifically, the restraining mechanism 200 may include a pair of end plates 210 and 220 arranged on the outside of the battery cells C arranged at the outermost side in the longitudinal direction Z1, and a pair of side plates 230 extending in the longitudinal direction Z1 to connect the pair of end plates 210 and 220 to each other. The pair of end plates 210 and 220 formed on both sides of the battery pack in the longitudinal direction Z1 may provide a compressive force in the longitudinal direction Z1 to the plurality of battery cells C, and the pair of side plates 230 formed on both sides of the battery pack in the transverse direction may distribute an external impact applied in the transverse direction to the plurality of battery cells C arranged in the longitudinal direction Z1. For example, the side plates 230 may distribute the external impact applied in the transverse direction to the plurality of friction sheets F arranged together with the plurality of battery cells C, thereby allowing the plurality of friction sheets F to resist against an external impact in the transverse direction while exerting a friction force together. In addition, the side plates 230 may be connected to the pair of end plates 210 and 220 such that the pair of end plates 210 and 220 are pressed toward each other in the longitudinal direction Z1, and thus, a compressive force may be applied to the plurality of battery cells C between the pair of end plates 210 and 220.

The end plates 210 and 220 and the side plates 230 overlap each other at the four corners of the battery pack to be bonded to each other by fastening screws or welding. In one embodiment of the present disclosure, the restraining mechanism 200 may include a plurality of the plates 210, 220, and 230 surrounding the plurality of battery cells C arranged in the longitudinal direction Z1, and the restraining mechanism 200 is not limited thereto, and for example, may also be provided in the form of a band surrounding the plurality of battery cells C arranged in the longitudinal direction Z1, and in various embodiments, the restraint mechanism 200 may bind the plurality of battery cells C arranged in the longitudinal direction Z1 in the form of one pack and may be provided in various forms within a range of providing a compressive force in the longitudinal direction Z1 for a frictional bond of the friction sheets F in the transverse direction.

The restraining mechanism 200 may provide a compressive force in the longitudinal direction Z1 to bind the plurality of battery cells C arranged in the longitudinal direction Z1 in the form of one pack and for the frictional bond of the friction sheets F in the transverse direction. In one embodiment of the present disclosure, the compressive force provided by the restraining mechanism 200 in the longitudinal direction Z1 may be in a range of 2000N to 5000N. When the compressive force provided by the restraining mechanism 200 is less than a lower limit value, the compressive force provided by the restraining mechanism 200 is not sufficient and a lateral stiffness of the battery pack provided by the frictional bond of the friction sheet F is insufficient, and thus, the plurality of battery cells C may be out of a regular position due to an external impact applied in the transverse direction.

When the compressive force provided by the restraining mechanism 200 is excessively provided out of an upper limit value, the plurality of battery cells C may be deformed due to the compressive force provided by the restraining mechanism 200, or the restraining mechanism 200 does not accommodate volume expansion caused by swelling of the battery cells C and an internal stress induced by the volume expansion of the battery cells C is accumulated therein, and thus, durability of the restraining mechanism 200 may be affected thereby.

Referring to FIGS. 4 and 5, the heat insulating sheet I may be between the battery cell C and the friction sheet F. The heat insulating sheet I may block a thermal interference between the plurality of battery cells C arranged in the longitudinal direction Z1 and may block or delay that heat or ignition of one battery cell C is propagated toward another battery cell C adjacent thereto.

In one embodiment of the present disclosure, the heat insulating sheet I may be formed of any material having a thermal insulation to sufficiently block the thermal interference between the adjacent battery cells C. More specifically, in one embodiment of the present disclosure, the heat insulating sheet I may include MICA or aerogel.

The aerogel may include silicon dioxide (SiO₂) as a main component. The aerogel particle content in the heat insulating sheet I is 80% or more, and the rest thereof may be made of a binder. Specifically, the aerogel particle content may be comprised of about 80% to about 90%. Here, when the aerogel particle content is less than 80%, heat propagation between the adjacent battery cells C may not be blocked sufficiently, and when the aerogel particle content is greater than 90%, binder content may be relatively small to cause the heat insulating sheet I to be difficult to be formed. The aerogel particles may have a size of about 10 μm to about 100 μm, and 90% or more of the aerogel particles may be formed in nano-sized pores. As such, in an embodiment of the present disclosure, the heat insulating sheet I has more than 90% of the aerogel particles with nano-sized pores, and thus, the heat insulating sheet I may have excellent heat insulation performance while being lightweight.

In one embodiment of the present disclosure, the heat insulating sheet I may have a micropore structure formed in a nano-sized composite structure connected by a SiO₂ structure, and air may be accommodated in the micropore structure. An air layer may be maintained without moving in the SiO2 composite structure, and thus, air exhibiting excellent thermal insulation properties may be used as a heat insulator.

The heat insulating sheet I may have a form of a whole sheet and may be formed substantially over the entire main surface M of the battery cell C, and thus, insulate between a pair of adjacent battery cells C. Unlike the heat insulating sheet I, the friction sheet F may have a form of a sheet including a central opening FO to extend along an edge region of the main surface M of the battery cell C.

More specifically, the friction sheet F may include the central opening FO and an edge portion FP extending in a closed form to surround the central opening FO. The central opening FO formed in the friction sheet F may provide a free space to absorb volume expansion due to swelling of the battery cell C. That is, the volume expansion due to the swelling of the battery cell C may be allowed through the free space provided through the central opening FO, and internal stress due to the swelling of the battery cell C may be reduced, and a durability problem of the restraining mechanism 200 (see FIG. 1) according to accumulation of the internal stress may be solved.

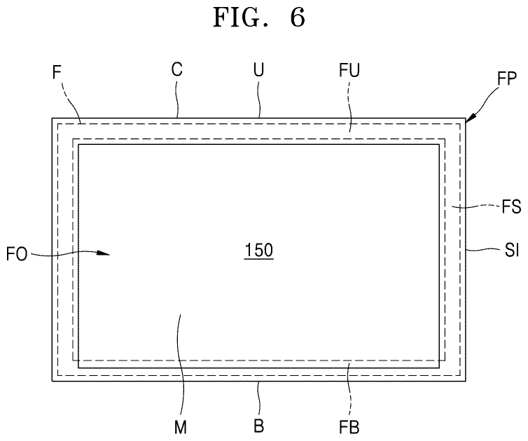

FIG. 6 is a view illustrating an arrangement relationship between a friction sheet and an electrode assembly. In FIG. 6, a detailed illustration of a battery cell is omitted for the sake of convenient understanding.

The edge portion FP of the friction sheet F may face the main surface M of the battery cell C and extend along an edge of the main surface M and include an upper portion FU adjacent to an upper surface U of the battery cell C, a bottom portion FB adjacent to a bottom surface B of the battery cell C, and side portions FS adjacent to side surfaces SI of the battery cell C. In addition, the upper portion FU and the side portions FS of the friction sheet F may be formed at positions that do not overlap the electrode assembly 150, and the bottom portion FB of the friction sheet F may be formed at a position that overlaps the electrode assembly 150. The arrangement of the friction sheet F may be made by considering heat generation according to a position of the battery cell C and swelling of the battery cell C according thereto.

In one embodiment of the present disclosure, current collectors 117 and 127 (see FIG. 3) for electrically connecting the electrode assembly 150 to the electrode terminals 110 and 120 may be connected to an upper portion of the electrode assembly 150, and charging and discharging currents may be concentrated in the collectors 117 and 127 to cause intensive heat generation, and thus, the upper portion of the electrode assembly 150 connected to the current collectors 117 and 127 may have relatively large heat generation and swelling compared to a bottom portion of the electrode assembly 150. Accordingly, the upper portion of the electrode assembly 150 having relatively large heat generation and swelling may be formed so as not to overlap the upper portion FU of the friction sheet F, and the opening FO of the friction sheet F, rather than the edge portion FP, may be formed at a position overlapping the upper portion of the electrode assembly 150, and thus, swelling of the upper portion of the electrode assembly 150 may be allowed. In addition, the bottom portion of the electrode assembly 150 having a relatively small heat generation may overlap the bottom portion FB of the friction sheet F. In addition, the side portions FS adjacent to the upper portion FU of the friction sheet F may not overlap the electrode assembly 150 (side portions FS of the electrode assembly 150), and the opening FO of the friction sheet F rather than the edge portion FP of the friction sheet F may be formed at positions that overlap the side portions of the electrode assembly 150, and thus, swelling of the side portions of the electrode assembly 150 may be allowed. As such, the upper portion FU and the side portions FS of the friction sheet F may be formed so as not to overlap the electrode assembly 150, and the bottom portion FB of the friction sheet F may be formed at a position that overlaps the electrode assembly 150.

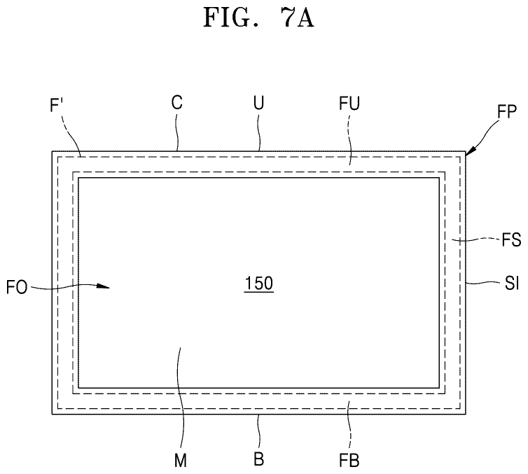

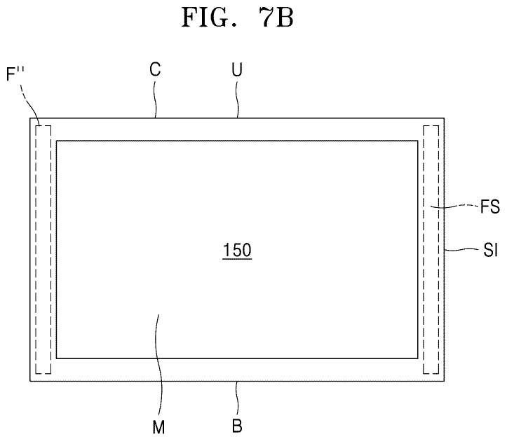

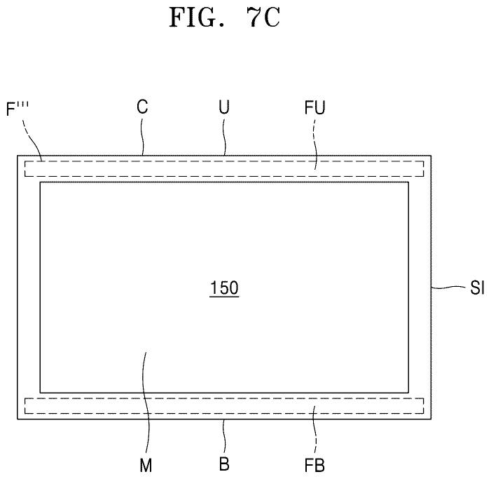

FIGS. 7A to 7C are views illustrating modified embodiments of the friction sheet illustrated in FIG. 6.

In the embodiment illustrated in FIG. 7A, a friction sheet F′ may be arranged at a position that does not overlap the electrode assembly 150. That is, an upper portion FU, side portions FS, and a bottom portion FB of the friction sheet F′ may be arranged at positions that do not overlap the electrode assembly 150.

In the embodiment illustrated in FIG. 7B, a friction sheet F″ may include a pair of side portions FS arranged at positions adjacent to the side surfaces SI of the battery cell C and may be formed in a stripe pattern including a pair of side portions FS extending in parallel at positions adjacent to the side surfaces SI of the battery cell C without surrounding the main surface M of the battery cell C in a closed form. In this case, the friction sheet F″ may be arranged at a position that does not overlap the electrode assembly 150.

In the embodiment illustrated in FIG. 7C, a friction sheet F″ may have an upper portion FU and a bottom portion FB respectively arranged at positions adjacent to the upper surface U and the bottom surface B of the battery cell C and may be formed in a stripe pattern extending in parallel at positions adjacent to the upper surface U and the bottom surface B of the battery cell C without surrounding the main surface M of the battery cell C in a closed form. In this case, the friction sheet F″ may be arranged at a position that does not overlap the electrode assembly 150.

Hereinafter, a battery pack according to another aspect of the present disclosure is described.

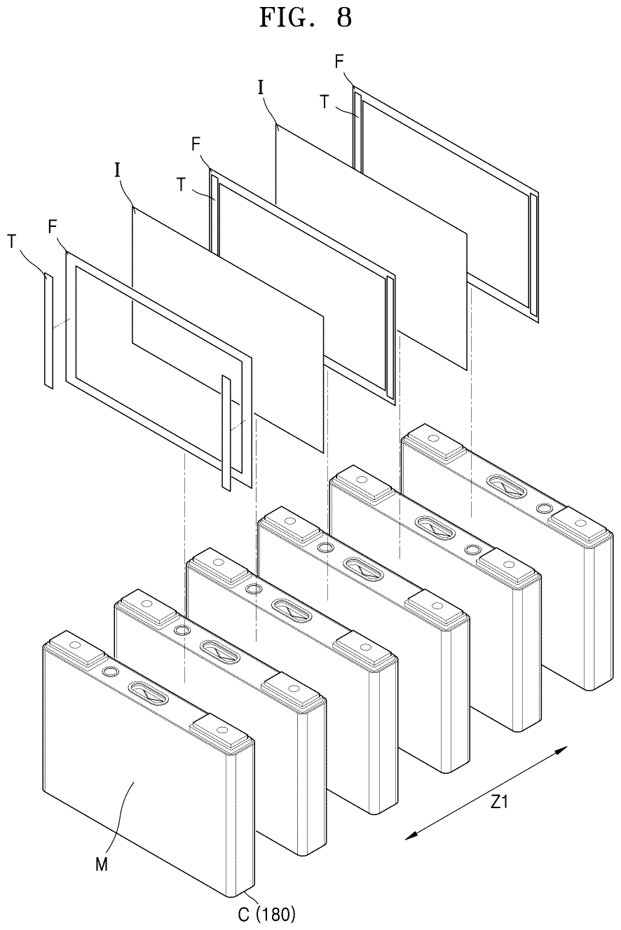

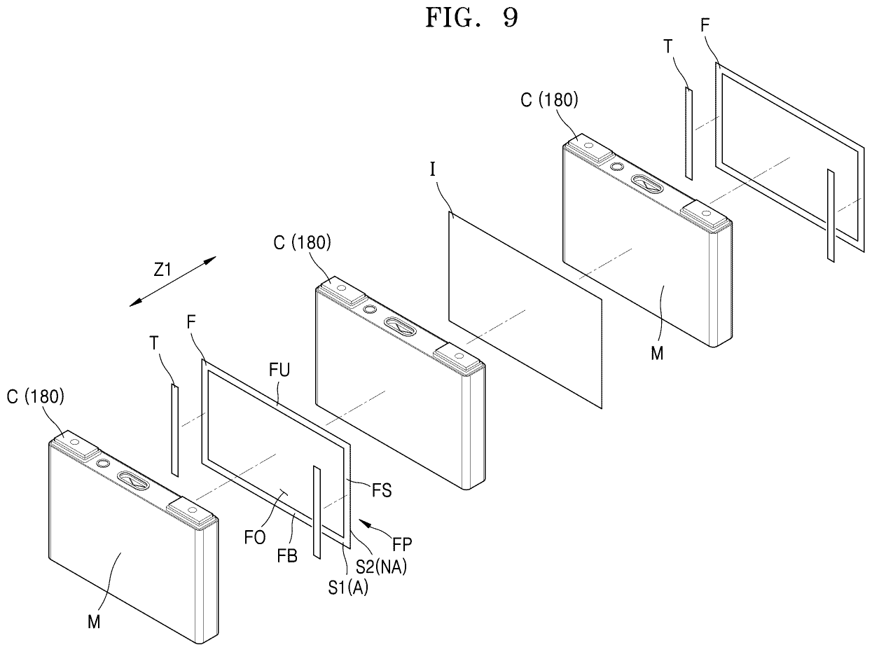

FIGS. 8 and 9 are perspective views illustrating another embodiment of the present disclosure and illustrating the friction sheets F and the insulating sheets I between the battery cells C illustrated in FIG. 1.

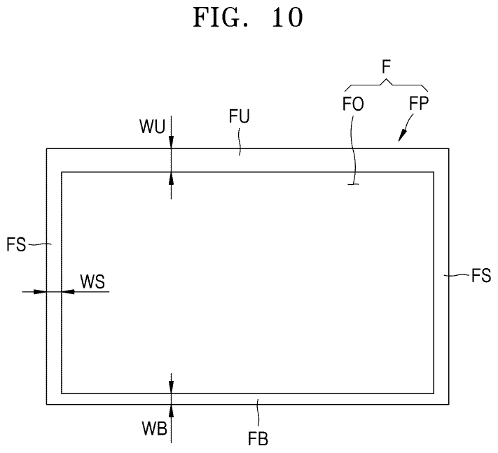

FIG. 10 is a view illustrating an example of the friction sheet F illustrated in FIGS. 8 and 9.

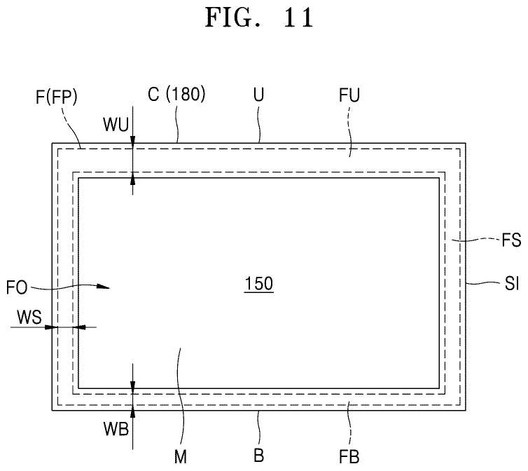

FIG. 11 is a view illustrating an arrangement relationship between the friction sheet F illustrated in FIG. 10 and an electrode assembly 150.

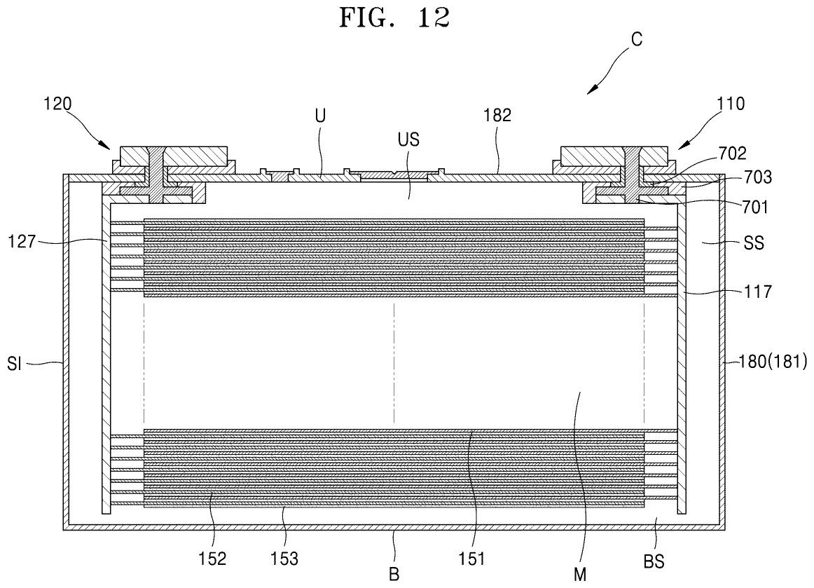

FIG. 12 is a view illustrating different line widths of an upper portion FU, side portions FS, and a bottom portion FB forming the friction sheet F illustrated in FIG. 11, and illustrating a configuration of the line widths differentially formed according to an internal space of the casing member 180 of the battery cell C facing the friction sheet.

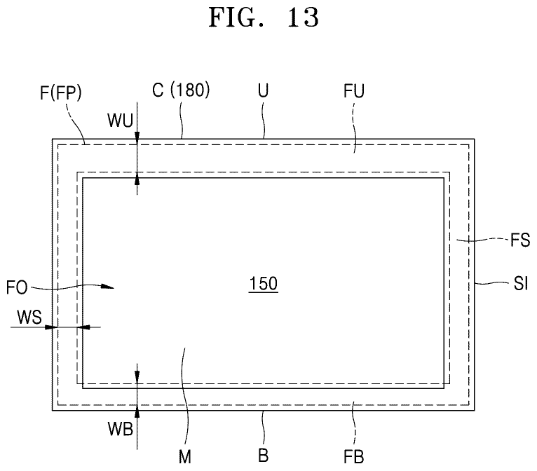

FIG. 13 is a view illustrating another arrangement relationship between the friction sheet F and the electrode assembly 150 as a modified example of the arrangement relationship between the friction sheet F and the electrode assembly 150 illustrated in FIG. 11.

Referring to FIGS. 8 and 9, a battery pack according to an embodiment of the present disclosure may include a plurality of battery cells C arranged in a longitudinal direction Z1, and the insulating sheets I and friction sheets F which are between the plurality of battery cells C and alternately arranged between the pairs of battery cells C arranged in an alternating order in a longitudinal direction Z1 in which the plurality of battery cells C are arranged.

As described below, the insulating sheet I and the friction sheet F may be arranged alternately along the longitudinal direction Z1 in which a plurality of battery cells C are arranged. For example, the insulating sheet I and the friction sheet F may be arranged alternately so as not to overlap each other between adjacent battery cells C. The insulating sheet I and the friction sheet F may be arranged in units of a pair of battery cells C and may also be arranged in units of another pair of battery cells C.

For example, the plurality of battery cells C may be arranged in the longitudinal direction Z1 such that main surfaces M of the battery cells C face each other, the insulating sheet I may be formed in a sheet shape to cover the central portion of the main surface M of the battery cell C, and the friction sheet F may include a central opening FO formed in the central portion of the main surface M of the battery cell C and an edge portion FP surrounding the central opening FO.

Here, the insulating sheet I may substantially cover the entire main surface M of the battery cell C, including the central portion of the main surface M of the battery cell C.

For example, the edge portion FP of the friction sheet F may have a closed shape surrounding the central opening FO. For example, the friction sheet F may have a closed loop shape surrounding the central opening FO. As described below, the edge portion FP of the friction sheet F may include the upper portion FU adjacent to an upper surface U of the battery cell C or an upper surface U of the casing member 180 of the battery cell C, the bottom portion FB adjacent to a bottom surface B of the battery cell C or a bottom surface B of the casing member 180 of the battery cell C, and the side portions FS adjacent to a side surface S1 of the battery cell C or a side surface S1 of the casing member 180 of the battery cell C, and may have a closed loop shape surrounding the central opening FO as a whole.

In an embodiment of the present disclosure, the insulating sheets I may be arranged to be spaced apart from each other in units of a pair of battery cells C arranged to be adjacent to each other, with the friction sheets F therebetween in the longitudinal direction Z1 in which the plurality of battery cells C are arranged. For example, in an embodiment of the present disclosure, the insulating sheets I may be arranged in units of a pair of battery cells C in the longitudinal direction Z1 in which the plurality of battery cells C are arranged. That is, the insulating sheets I may be arranged in units of a pair of battery cells C or two battery cells C, and rather than each being arranged between a pair of battery cells C in the longitudinal direction Z1 in which the plurality of battery cells C are arranged, the insulating sheets I may each be arranged between two pairs of adjacent battery cells C in the longitudinal direction Z1, that is, the insulating sheets I may each be arranged every two battery cells C arranged in the longitudinal direction Z1.

In an embodiment of the present disclosure, similarly to the arrangement of the insulating sheets I, the friction sheets F may be arranged in units of a pair of battery cells C in the longitudinal direction (the first direction) Z1 in which the plurality of battery cells C are arranged. For example, the friction sheets F may each be arranged between two pairs of battery cells C or every two battery cells C rather than each being arranged between a pair of battery cells C in the longitudinal direction Z1 in which the plurality of battery cells C are arranged. In this way, in an embodiment of the present disclosure, the arrangement of the insulating sheet I and the friction sheet F may be similar to each other, such that each pair of battery cells C may be arranged in the longitudinal direction Z1 in which the plurality of battery cells C are arranged, with each pair of battery cells C as a unit. That is, rather than being arranged between every battery cell C along the longitudinal direction Z1 in which the plurality of battery cells C are arranged, each pair of battery cells C or each two battery cells C may be arranged. In this way, the arranged positions of the insulating sheet I and the friction sheet F having similar arrangement structures may be differentially allocated to each other. For example, the insulating sheet I and the friction sheet F may be arranged in differentially exclusive positions rather than being arranged to overlap each other between the facing battery cells C, and the arranged positions of the insulating sheet I and the friction sheet F may be arranged between different pairs of battery cells C in units of different pairs of battery cells C so as not to overlap each other.

For example, the friction sheet F may be arranged to be spaced apart from each other in units of a pair of battery cells C adjacent to each other with the insulation sheet I therebetween in the longitudinal direction Z1 in which the plurality of battery cells C are arranged. That is, rather than being arranged to overlap the insulation sheet I between a pair of battery cells C adjacent to each other with the insulation sheet I therebetween, the friction sheet F may be arranged so as not to overlap the insulation sheet I at positions on both sides of the pair of battery cells C with the insulation sheet I therebetween.

Similarly, the insulating sheet I may be arranged to be spaced apart from each other in units of a pair of battery cells C adjacent to each other with the friction sheet F therebetween in the longitudinal direction Z1 in which the plurality of battery cells C are arranged. That is, rather than being arranged to overlap the friction sheet F between the pair of battery cells C arranged adjacent to each other with the friction sheet F therebetween, the insulating sheet I may be arranged so as not to overlap the friction sheet F at positions on both sides of the pair of battery cells C arranged adjacent to each other with the friction sheet F therebetween.

For example, in an embodiment of the present disclosure, unlike the embodiment of the present disclosure illustrated in FIG. 5, the insulating sheet I may not be arranged every battery cell C in the longitudinal direction Z1, but may be arranged every pair of battery cells C in units of one pair of battery cells C to block heat propagation. For example, in an embodiment of the present disclosure, the insulating sheet I may be formed for the purpose of blocking heat propagation from an overheated battery cell C to another adjacent battery cell C and blocking the chain thermal runaway of another battery cell C adjacent to the battery cell C overheated due to heat propagation. In an embodiment of the present disclosure, an arrangement structure in which the insulation sheets I are arranged in units of a pair of battery cells C including adjacent battery cells C may allow heat propagation between the adjacent battery cells C forming a pair, but, for example, the insulating sheets I may be arranged in units of a pair of battery cells C so as not to allow further heat propagation in units of the pair of battery cells C including adjacent battery cells C. For example, in an embodiment of the present disclosure, although the insulating sheet I blocks the heat propagation in units of a pair of battery cells C, it is possible to prevent the overall ignition, chain ignition, or explosion of the battery pack including the plurality of battery cells C. For example, when the heat propagation between adjacent battery cells C is understood as heat propagation from a surface of an overheated battery cell C toward a surface of another adjacent battery cell C, the temperature of the surface of the overheated battery cell C may be substantially the same when the insulating sheet I is arranged for each battery cell C in the longitudinal direction Z1 or when the insulating sheet I is arranged for each pair of battery cells C. However the entire amount of heat dissipation or heat energy may increase through the heat propagation between adjacent battery cells C. In an embodiment of the present disclosure, the explosion or ignition of the entire battery pack may be prevented through the insulating sheets I arranged in units of a pair of battery cells C, and depending on the arrangement structures of the insulating sheets I, rather than arranging the insulation sheets I for each battery cell C, by arranging the insulation sheets I for each pair of battery cells C, the cost burden due to a material cost or assembly cost of the insulation sheets I may be reduced while preventing the risk of ignition or explosion of the battery pack.

In an embodiment of the present disclosure, in addition to the insulating sheet I, the friction sheet F may be between adjacent battery cells C arranged in the longitudinal direction Z1 in which the plurality of battery cells C are arranged. For example, the friction sheet F may be arranged in addition to the insulating sheet I to maintain lateral rigidity of the battery pack including the plurality of battery cells C arranged in the longitudinal direction Z1 as described in the embodiment illustrated in FIG. 5. In an embodiment of the present disclosure, the insulating sheet I and the friction sheet F may be arranged at mutually exclusive positions so as not to overlap each other, and for example, the insulating sheet I or the friction sheet F may be selectively arranged between adjacent battery cells C included in the plurality of battery cells C arranged in the longitudinal direction Z1. The insulating sheet I and the friction sheet F may not be arranged to overlap each other between adjacent battery cells C, and for example, the insulating sheet I and the friction sheet F may not form a structure (for example, a structure in which the insulating sheet I and the friction sheet F are stacked consecutively between identical adjacent battery cells C) in which the insulating sheet I and the friction sheet F are stacked with respect to each other between adjacent battery cells C. Accordingly, unlike the embodiment illustrated in FIG. 5, by arranging the insulating sheet I and first and second friction sheets F on both sides of the insulating sheet I between adjacent battery cells C, it is possible to prevent the volume of the battery pack from increasing in the longitudinal direction Z1 while preventing the energy density from decreasing for the same volume, and while it is possible to simplify an assembly process through simplification of the structure, it is possible to prevent explosion or ignition of the battery pack through the insulation sheets I arranged in units of a pair of battery cells C as described below. In addition, sufficient lateral rigidity may be provided against an external impact that follows the longitudinal direction Z1 of the battery pack in which a plurality of battery cells C are arranged, through the friction sheets F arranged in units of a pair of battery cells C. For example, in an embodiment of the present disclosure, unlike the embodiment illustrated in FIG. 5, the friction sheet F may not be arranged together with the insulating sheet I and another friction sheet F (either one of the first friction sheet F1 and the second friction sheet F2) between adjacent battery cells C, and through a single insulating sheet I between adjacent battery cells C, sufficient lateral rigidity of the battery pack may be provided through sufficient pressure (frictional force that uses sufficient pressure as a normal force) without pressure absorption by the insulation sheet I and another friction sheet F between adjacent battery cells C.

In an embodiment of the present disclosure, the friction sheet F (including the upper portion FU, the bottom portion FB, and the side portions FS to surround the central opening FO) has a frame shape surrounding the central opening FO, and may absorb swelling of the battery cell C through the central opening FO. For example, the friction sheet F may effectively absorb the swelling of the battery cell C through the central opening FO facing a central portion of the battery cell C where the swelling may be more significant than the swelling of a corner portion having relatively high rigidity. For example, the friction sheet F in the form of an edge (a closed form or closed loop form) surrounding the central opening FO may be provided to absorb the swelling of the battery cell C in units of a pair of battery cells C.

In an embodiment of the present disclosure, the insulating sheets I and the friction sheets F may be alternately arranged between the plurality of battery cells C arranged in the longitudinal direction Z1, thereby blocking an electrical interference between adjacent battery cells C and providing electrical insulation between the adjacent battery cells C. Regarding physical interference between the adjacent battery cells C, the friction sheet F having the central opening FO may be between each pair of battery cells C to absorb the swelling (volume expansion), and regarding a thermal interference between adjacent battery cells C, the insulating sheet I having a complete sheet shape to cover the center of each pair of battery cells C is provided between each pair of battery cells C, thereby blocking heat propagation or thermal runaway.

For example, in an embodiment of the present disclosure, in a pair of first and second battery cells C arranged adjacent to each other in the longitudinal direction Z1 in which the plurality of battery cells C are arranged, a first surface S1 of the friction sheet F facing the first battery cell C may be formed as an adhesive surface A, and a second surface S2 of the friction sheet F facing the second battery cell C may be formed as a non-adhesive surface NA. For example, among the first and second battery cells C arranged adjacent to each other with the friction sheet F therebetween, an adhesive member T may be between the first battery cell and the first surface S1 of the friction sheet F facing the first battery cell C.

For example, as described in the embodiment illustrated in FIG. 5, the first surface S1 of the friction sheet F may be formed as the adhesive surface A, and the second surface S2 of the friction sheet F opposite to the first surface S1 may be formed as the non-adhesive surface NA, and accordingly, an assembly process of the friction sheet F may be simplified, and sufficient lateral rigidity (lateral rigidity of the battery pack) may be provided by the friction sheet F. That is, the first surface S1 and the second surface S2) of the friction sheet F interposed in units of a pair of battery cells C may be respectively the adhesive surfaces A and the non-adhesive surfaces NA that are different from each other. For example, the first surface S1 and the second surface S2 of the friction sheet F may prevent relative slippage between a pair of battery cells C that are arranged to face each other through the friction sheet F, and may provide lateral rigidity. For example, the lateral rigidity of the battery pack may be based on the non-adhesive surface NA (the second surface S2) of the friction sheet F that may provide relatively low slippage resistance and the battery cell C, rather than on the adhesive surface A (the first surface S1) of the friction sheet F that may provide relatively high slippage resistance and the battery cell C. For example, in an embodiment of the present disclosure, a relatively high adhesive rigidity may be provided between the adhesive surface A (the first surface S1) of the friction sheet F and the battery cell C through the adhesive member T therebetween. In contrast to this, a relatively low frictional rigidity may be provided between the non-adhesive surface NA (the second surface S2) of the friction sheet F and the battery cell C according to the frictional force (the frictional force that may be represented by the form of a multiplication between a friction coefficient between the non-adhesive surface NA of the friction sheet (F) and the battery cell C and a vertical force that is the pressure acting between the adjacent battery cells C) therebetween, and the lateral rigidity of the battery pack may be defined based on the relatively weak friction rigidity (a frictional force between the non-adhesive surface NA of the friction sheet F and the battery cell C). For example, in an embodiment of the present disclosure, the friction coefficient, which is a major factor of the frictional force between the second surface (the non-adhesive surface NA) of the friction sheet F, which may define the lateral rigidity of the battery pack, and the battery cell C, may be in the range of 0.2 to 0.8. For example, in an embodiment of the present disclosure, the friction sheet F may include at least one material selected from a group consisting of silicone, polyurethane, TPU, and PSA.

In an embodiment of the present disclosure, the first battery cell C facing the first surface S1 of the friction sheet F and the second battery cell C facing the second surface S2 of the friction sheet F may be arranged alternately in the longitudinal direction Z1 in which the plurality of battery cells C are arranged. That is, in an embodiment of the present disclosure, the first and second battery cells C respectively facing the first and second surfaces S1 and S2 of the friction sheet F in the longitudinal direction Z1 in which the plurality of battery cells C are arranged may be arranged alternately, and may be arranged in the order of the first battery cell C, the second battery cell C, the first battery cell C, and the second battery cell C in the longitudinal direction Z1. For example, in an embodiment of the present disclosure, the arrangement of the friction sheets F and the insulating sheets I that are alternately arranged between the first battery cell C and the second battery cell C may be made in the order of the first battery cell C, the friction sheet F, the second battery cell C, the insulating sheet I, the first battery cell C, the friction sheet F, and the second battery cell C.

The battery pack according to an embodiment of the present disclosure may further include a restraining mechanism 200 (see FIG. 1) for providing a compressive force (or pressure) to the plurality of battery cells C from opposite end positions thereof in the longitudinal direction Z1 in which the plurality of battery cells C are arranged. For example, in an embodiment of the present disclosure, the restraining mechanism 200 may include plates 210, 220, and 230 that surround the plurality of battery cells C arranged in the longitudinal direction Z1, and more specifically, the restraining mechanism 200 may include a pair of end plates 210 and 220 arranged on an outer side of the battery cell C on the outermost side in the longitudinal direction Z1, and a pair of side plates 230 extending in the longitudinal direction Z1 to connect the pair of end plates (210, 220) to each other. As described in the embodiment illustrated in FIG. 5, the restraining mechanism 200 may provide a compressive force (for example, a vertical force for inducing a friction force between the friction sheet F and the second battery cell C) between the battery cells C to provide the frictional force between the friction sheet F and the battery cell C (for example, between the second surface (the non-adhesive surface) NA of the friction sheet F and the second battery cell C), and may structurally bind the plurality of battery cells C arranged in the longitudinal direction Z1 to form a battery pack. For example, in an embodiment of the present disclosure, the compressive force provided by the restraining mechanism 200 (see FIG. 1) in the longitudinal direction Z1 may range from 2,000 N to 5,000 N.

Referring to FIG. 11, in an embodiment of the present disclosure, each of the plurality of battery cells C included in a battery pack may include an electrode assembly 150 and a casing member 180 accommodating the electrode assembly 150. The casing member 180 may include an upper surface U on which electrode terminals 110 and 120 electrically connected to the electrode assembly 150 are formed, a bottom surface B opposite to the upper surface U, a pair of main surfaces M which are relatively wide and connect the upper surface U to the bottom surface B, and a pair of side surfaces SI which are relatively narrow and connect the upper surface U to the bottom surface B. For example, the friction sheet F may include an edge portion FP which faces the main surface M of the casing member 180 and extends along an edge of the main surface M. More specifically, the edge portion FP of the friction sheet F may include the upper portion FU at a position adjacent to the upper surface U of the casing member 180, the bottom portion FB at a position adjacent to the bottom surface B of the casing member 180, and the side portions FS at positions adjacent to the side surfaces SI of the casing member 180. The upper portion FU, the side portions FS, and the bottom portion FB of the friction sheet F may be continuously connected to each other, the friction sheet F may have a shape of a closed loop edge surrounding the central opening FO and may have an edge shape surrounding the central opening FO in a closed form. For example, the friction sheet F may include the central opening FO and the edge portion FP surrounding the central opening FO. The upper portion FU, the side portions FS, and the bottom portion FB of the edge portion FP, which substantially forms the friction sheet F, may correspond to the upper portion FU, the side portions FS, and the bottom portion FB of the friction sheet F.

Referring to FIGS. 11 and 12, in an embodiment of the present disclosure, a relative arrangement relationship may be established between the friction sheet F arranged to face the battery cell C and the electrode assembly 150 that forms the battery cell C. The friction sheet F, for example, the edge portion FP of the friction sheet F, which substantially forms the friction sheet F, may be arranged at a position which does not overlap the electrode assembly 150 of the battery cell C that causes swelling of the battery cell C. For example, the swelling of the battery cell C may be formed in a roll type in which a separator 153 is between the first electrode plate 151 and the second electrode plate 152 having opposite polarities and wound in a roll type, or in a stack type in which the separator 153 is between the first and second electrode plates 151 and 152 having opposite polarities and being stacked against each other. it may be understood that the electrode assembly 150 arranged to overlap each other in a roll type or stack type expands in volume (swells) due to a driving heat accompanied by charging and discharging. In order to absorb the volume expansion or swelling of the electrode assembly 150, the edge portion FP of the friction sheet F may be excluded from a position facing the electrode assembly 150, the central opening FO of the friction sheet F may be formed at the position facing the electrode assembly 150, and accordingly, swelling of the electrode assembly 150 or the battery cell C may be absorbed through the central opening FO of the friction sheet F. That is, the central opening FO of the friction sheet F may be formed at a position facing the electrode assembly 150 without overlapping the edge portion FP of the friction sheet F. In an embodiment of the present disclosure, a relative arrangement relationship may be established between the upper portion FU, the side portions FS, and the bottom portion FB included in the edge portion FP of the friction sheet F and the electrode assembly 150 of the battery cell C facing the friction sheet F. For example, the friction sheet F may be arranged along an internal space of the casing member 180 other than the electrode assembly 150. More specifically, the upper portion FU of the friction sheet F may be formed with a relatively great line width WU to correspond to an upper region US of the internal space of the casing member 180 other than an upper portion of the electrode assembly 150, and the bottom portion FB of the friction sheet F may be formed with a relatively small line width WB to correspond to the bottom region BS of the internal space of the casing member 180 other than a bottom portion of the electrode assembly 150. In addition, the side portions FS may be formed with an intermediate line width WS corresponding to a side region SS of the internal space of the casing member 180 other than a side portion of the electrode assembly 150, and may be formed with, for example, the line width that is less than the line width WU of the upper portion FU of the friction sheet F and greater than the line width WB of the bottom portion FB of the friction sheet F. That is, the line widths WU, WS, and WB of the upper portion (FU) of the friction sheet F, the side portions FS of the friction sheet F, and the bottom portion FB of the friction sheet F may have the following relationship in size.

Line width WU of upper portion FU of friction sheet F>line widths WS of side portion FS of friction sheet F>line width WB of bottom portion FB of friction sheet F.

Referring to FIG. 12, in an embodiment of the present disclosure, the battery cell C may include not only the electrode assembly 150 and the casing member 180 that accommodates the electrode assembly 150, but also current collectors 117 and 127 that electrically connect the electrode terminals 110 and 120 on an upper surface of the casing member 180 to the electrode assembly 150 and form charging and discharging paths. The internal space of the casing member 180 may accommodate the electrode assembly 150 and the current collectors 117 and 127 electrically connected to the electrode assembly 150. For example, in an embodiment of the present disclosure, connection portions 701 for electrically connecting the electrode terminals 110 and 120 on the upper surface U of the casing member 180 respectively to the current collectors 117 and 127 electrically connected to the electrode assembly 150 may be provided in the upper region US of the internal space of the casing member 180. The electrode terminals 110 and 120 may be connected to the current collectors 117 and 127 respectively through the connection portions 701, and charging and discharging paths penetrating the inside and outside of the casing member 180 may be formed therethrough. In addition, sealing portions 702 for blocking leakage of electrolyte between the inside and outside of the casing member 180, insulating portions 703 for insulating the charging and discharging paths between the electrode terminal 110 and 120 and the current collectors 117, 127 from the upper surface U of the casing member 180 on which the electrode terminal 110 and 120 are formed, and so on may be provided. In order to allocate spaces for arranging the connection portions 701, the sealing portions 702, and the insulating portions 703, the upper region US in the internal space of the outer material 180, that is, the upper region US of the internal space of the casing member 180 other than an upper portion of the electrode assembly 150, may be secured to be relatively wide. Accordingly. the upper portion FU of the friction sheet F (the edge portion FP of the friction sheet F) arranged along the upper region US of the internal space of the casing member 180 so as not to overlap the electrode assembly 150 may be formed with the relatively great line width WU, and for example, the upper portion FU may be formed with the greatest line width along the edge portion FP of the friction sheet F.

In an embodiment of the present disclosure, the current collectors 117 and 127 electrically connected to the electrode assembly 150 may be arranged in side regions SS in the internal space of the casing member 180, that is, in the side regions SS of the internal space of the casing member 180 other than side portions of the electrode assembly 150. The side regions SS in the internal space of the casing member 180 may be formed to secure an appropriate width to allow for an arrangement space of the current collectors 117 and 127. For example, as described above, the side regions SS may have a less width than the upper region US of the internal space of the casing member 180 in which the same current collectors 117 and 127 are arranged and a relatively greater width is required to secure additional arrangement of the connection portions 701, the sealing portions 702, the insulating portions 703, and so on and may have a greater width than the lower region BS of the internal space of the casing member 180 from which the current collectors 117 and 127 connected to the electrode assembly 150 are excluded. In view of this, the line widths WS of the side portions FS of the friction sheet F, which are arranged along the side regions SS of the internal space of the casing member 180 and formed so as not to overlap the electrode assembly 150, may be set in the following relationship. That is, line width WU of upper portion FU of friction sheet F>line width WS of side portion FS of friction sheet F>line width WB of bottom portion FB of friction sheet F.

In an embodiment of the present disclosure, the current collector 117 and 127 electrically connected to the electrode assembly 150 may be excluded from the lower region BS in the internal space of the casing member 180, that is, the lower region BS of the internal space of the casing member 180 other than a bottom portion of the electrode assembly 150. A design considering a substantially different arrangement structure may not be required for the lower region BS of the internal space of the casing member 180, and for example, the lower region BS is required to secure an appropriate gap between the bottom portion of the electrode assembly 150 and the casing member 180. The lower region BS of the internal space of the casing member 180 may have a less width than the side regions SS of the internal space of the casing member 180 in which the current collectors 117 and 127 electrically connected to the electrode assembly 150 are arranged, and may also have a less width than the upper region US of the internal space of the casing member 180 in which the connecting portions 701, the sealing portions 702, the insulating portions 703, and so on are additionally arranged together with the current collectors 117 and 127. In view of this, the bottom portion FB of the friction sheet F, which is arranged along the lower region BS of the inner space of the casing member 180 and arranged so as not to overlap the electrode assembly 150, may have a relatively small line width WB, for example, may be narrower than the upper portion FU and the side portions FS of the friction sheet F and may have the smallest line width WB along the edge portion FP of the friction sheet F.

As described above, the friction sheet F or the edge portion FP of the friction sheet F which substantially forms the friction sheet F may include the upper portion FU (for example, the greatest line width WU), and the side portions FS and the bottom portion FB (for example, the smallest line width WB) which are formed with differential line widths according to a spatial arrangement of the internal space of the casing member 180 in which the electrode assembly 150 is accommodated so as not to overlap the electrode assembly 150 of the battery cell C facing the friction sheet F. Referring to FIG. 13, in various embodiments of the present disclosure, an upper portion (for example, an upper portion of the electrode assembly 150 adjacent to the connection portions 701 between the current collectors 117 and 127 and the electrode terminals 110 and 120) of the electrode assembly 150 adjacent to the current collectors 117 and 127 along trajectories of the current collectors 117 and 127 that form charging and discharging paths between the electrode terminals 110 and 120 formed on an upper surface (an upper surface of the casing member 180) of the battery cell C and the electrode assembly 150 and that may cause concentrated heat due to concentration of charging and discharging currents, and side portions (for example, side portions of the electrode assembly 150 respectively connected to the current collectors 117 and 127) of the electrode assembly 150 may cause concentrated swelling due to relatively high temperature at the upper portion of the electrode assembly 150. Accordingly, the upper portion FU and the side portions FS of the edge portion FP of the friction sheet F may not overlap the electrode assembly 150 of the battery cell C facing the friction sheet F. Unlike this, the bottom portion FB of the edge portion FP of the friction sheet F may overlap at least part of the electrode assembly 150 of the battery cell C facing the friction sheet F. As described above, the bottom portion FB of the friction sheet F, which is formed with the smallest line width WB in a structure where the bottom portion FB of the friction sheet F does not overlap the electrode assembly 150 (see FIG. 11), may have the greater line width WB in a structure where the bottom portion FB of the friction sheet F overlaps the electrode assembly 150 (see FIG. 13). For example, the line width WB of the bottom portion FB of the friction sheet F may be equivalent to the line widths WS of the side portions FS of the friction sheet F. In view of this, a line width of the friction sheet F or the edge portion FP of the friction sheet F may satisfy the following relationship. That is, line width WU of upper portion FU of friction sheet F>line width WS of side portion FS of friction sheet F=line width WB of bottom portion FB of friction sheet F.

In an embodiment of the present disclosure, the friction sheet F may absorb swelling of the battery cell C facing the friction sheet F through the central opening FO, and may prevent, for example, an ignition explosion of the battery cell C that may be caused by excessively suppressing the swelling of the battery cell C, and may also provide lateral rigidity of a battery pack including the plurality of battery cells C through the non-adhesive surface NA formed by the second surface S2 of the friction sheet F. In this case, in an embodiment of the present disclosure, depending on the degree of swelling predicted from the arrangement of the electrode assembly 150 forming the battery cell C or the arrangement of the current collectors 117 and 127 connected to the electrode assembly 150 forming the battery cell C, and so on, the friction sheet F (the edge portion FP of the friction sheet F) having a differential line width may be formed, and an area of the non-adhesive surface NA formed by the second surface S2 of the friction sheet F may be increased by increasing a line width of the friction sheet F in the range in which swelling may be absorbed. Accordingly, it is possible to form a sufficient frictional force between the non-adhesive surface NA formed by the second surface S2 of the friction sheet F and the battery cell C, that is, a sufficient frictional force that may secure lateral rigidity of a battery pack including the plurality of battery cells C.

Referring to FIGS. 8 and 9, in an embodiment of the present disclosure, the insulating sheet I may have a complete sheet shape to cover at least the center of the battery cell C such that a thermal interference between adjacent battery cells C may blocked, and more specifically, may have a complete sheet shape to entirely cover the main surface M of the battery cell C. For example, the insulating sheet I may be between a pair of adjacent battery cells C, and the insulating sheet I may form the adhesive surface A between the facing battery cells C through an adhesive member, or may also form the non-adhesive surface NA between the facing battery cells C without the adhesive member. For example, in an embodiment of the present disclosure, the insulating sheet I may include MICA or aerogel.

According to the battery pack of the present disclosure, a battery pack including a plurality of battery cells reduces an assembly cost and man-hours for assembling a large number of battery cells, while strengthening lateral rigidity and increasing impact resistance against an external impact applied in the transverse direction intersecting the longitudinal direction in which the battery cells are arranged.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A battery pack comprising:
a plurality of battery cells arranged in a longitudinal direction; and
an insulating sheet and a friction sheet provided between adjacent pairs of battery cells among the plurality of battery cells, and arranged in an alternating order between adjacent pairs of battery cells in the longitudinal direction in which the plurality of battery cells are arranged.

2. The battery pack of claim 1, wherein
the plurality of battery cells are arranged in the longitudinal direction such that main surfaces of the plurality of battery cells face each other,
the insulating sheet has a sheet shape to cover a central portion of the main surface of the battery cell, and
the friction sheet includes a central opening formed in the central portion of the main surface of the battery cell and an edge portion surrounding the central opening.

3. The battery pack of claim 2, wherein the edge portion of the friction sheet has a closed shape surrounding the central opening.

4. The battery pack of claim 1, wherein a plurality of insulating sheets are arranged to be spaced apart from each other in units of a pair of battery cells between the plurality of battery cells arranged in the longitudinal direction, with the friction sheet therebetween.

5. The battery pack of claim 1, wherein a plurality of friction sheets are arranged to be spaced apart from each other in units of a pair of battery cells between the plurality of battery cells arranged in the longitudinal direction, with the insulating sheet therebetween.

6. The battery pack of claim 1, wherein, in a pair of a first battery cell and a second battery cell arranged adjacent to each other in the longitudinal direction in which the plurality of battery cells are arranged, with the friction sheet therebetween, a first surface of the friction sheet facing the first battery cell is formed as an adhesive surface, and a second surface of the friction sheet facing the second battery cell is formed as a non-adhesive surface.

7. The battery pack of claim 6, wherein an adhesive member is provided between the first battery cell and the first surface of the friction sheet.

8. The battery pack of claim 6, wherein a friction coefficient between the second battery cell and the second surface of the friction sheet ranges from 0.2 to 0.8.

9. The battery pack of claim 8, wherein the friction sheet includes at least one of silicone, polyurethane, TPU, and PSA.

10. The battery pack of claim 6, wherein the first battery cell facing the first surface of the friction sheet and the second battery cell facing the second surface of the friction sheet are arranged in an alternating order in the longitudinal direction in which the plurality of battery cells are arranged.

11. The battery pack of claim 6, further comprising a restraining mechanism configured to provide a compressive force to the plurality of battery cells from both ends of the restraining mechanism in the longitudinal direction in which the plurality of battery cells are arranged.

12. The battery pack of claim 11, wherein the restraining mechanism includes plates surrounding the plurality of battery cells arranged in the longitudinal direction.

13. The battery pack of claim 11, wherein the restraining mechanism includes a pair of end plates arranged in an outer periphery of an outermost battery cell in the longitudinal direction, and a pair of side plates extending in the longitudinal direction to connect the pair of end plates to each other.

14. The battery pack of claim 11, wherein the compressive force provided by the restraining mechanism in the longitudinal direction ranges from 2,000 N to 5,000 N.

15. The battery pack of claim 1, wherein
each of the plurality of battery cells includes an electrode assembly and a casing member configured to accommodate the electrode assembly, and
the casing member includes an upper surface on which electrode terminals electrically connected to the electrode assembly are formed, a bottom surface opposite to the upper surface, a pair of relatively wide main surfaces connecting the upper surface to the bottom surface, and a pair of relatively narrow side surfaces connecting the upper surface to the bottom surface.

16. The battery pack of claim 15, wherein the friction sheet includes an edge portion facing the pair of main surfaces of the casing member and extending along edges of the pair of main surfaces.

17. The battery pack of claim 16, wherein the edge portion of the friction sheet includes an upper portion adjacent to the upper surface of the casing member, a bottom portion adjacent to the bottom surface of the casing member, and side portions adjacent to the side surfaces of the casing member.

18. The battery pack of claim 17, wherein a line width of the upper portion of the edge portion, a line width of the side portions of the edge portion, and a line width of the bottom portion of the edge portion satisfy a size relationship (line width of upper portion>line widths of side portions>line width of bottom portion).

19. The battery pack of claim 17, wherein
the upper portion and the side portions of the edge portion do not overlap the electrode assembly, and
the bottom portion of the edge portion overlaps at least part of the electrode assembly.

20. The battery pack of claim 1, wherein the insulating sheet includes one of MICA and an aerogel.
